(19) United States
(12) Patent Application Publication
(10) Pub. No.: US 2014/0169645 A1
(43) Pub. Date: Jun. 19, 2014

(54) METHOD AND SYSTEM FOR MEDICAL IMAGING DATA MANAGEMENT

(71) Applicant: ADVANCED MEDICAL IMAGING DEVELOPMENT S.R.L, Sulmona (IT)

(72) Inventors: Giovanni TONTI, Sulmona (IT); Gianni PEDRIZZETTI, Prato (IT); Alberto ACQUAFRESCA, Vaiano (IT)

(73) Assignee: Advanced Medical Imaging Development S.R.L., Sulmona (IT)

(21) Appl. No.: 13/715,358

(22) Filed: Dec. 14, 2012

(51) Int. Cl. G06F 17/30

(52) U.S. Cl. CPC G06F 17/30244
USPC 382/128

(57) ABSTRACT

A method and a corresponding system and medical data repository for medical imaging data management including: receiving medical images associated with an exam of a patient; storing the medical images; receiving clinical information derived from the medical images; arranging the clinical information in a database structured to allow retrieval of such clinical information independently from the retrieval of the stored medical images.

### TECHNICAL FIELD

The present invention relates to a method and a system for managing medical data, particularly medical images in distributed cloud environments.

### BRIEF DISCUSSION OF RELATED ART

Nowadays most of the diagnostic solutions are made by means of medical imaging technology. Medical imaging gave a tremendous burst to the ability to improve diagnosis, and to devise adequate therapeutic solution. Medical imaging is a term comprising several technologies, including Echography, MR, CT, radiography, angiography etc. The same term is used to indicate individual images, running clips made of several (even hundreds) images, or three-dimensional volumetric acquisitions, or, lately, even sequence of three-dimensional volumetric acquisitions (so-called 4D imaging, like the 3D recording of beating heart).

Medical imaging are now generated in digital format and stored in computer-driven digital devices. Given the relevance of medical imaging for diagnostic purposes, and the large amount of medical imaging production, the issue of storage, archiving, and retrieval of medical images has become a central element in the health management process. Several solutions are available for the storage and retrieval of medical images. Such solutions employ simply storage on local computers, or local area network servers, up to storage solutions distributed on the web, or to cloud storage dedicated to medical imaging.

Medical images are commonly stored in the DICOM (Digital Imaging and Communication in Medicine) format, which is a standard set of rules to encode image data from any different modality and accompany images with additional medical information that are integrative, from ECG, pressure curves, to type of exam, equipment employed, to identification codes. The DICOM format contains individual images, playing sequences or clips, sequences that compose 3D volumetric information, or sequences of 3D volumetric info, as well as fusion imaging obtained by combination of multimodality.

Every set of acquired medical images is composed by one or several DICOM files that pertain to an individual exam. That set is temporarily available on the recording equipment, or attached workstation, and it is then archived on a storage system. Storage is mandatory for some clinical fields in several countries and it is becoming common habit for good healthcare. Systems for the storage of medical imaging often go under the name of Picture Archiving Communication System (PACS) that includes the possibility of image retrieval for later visualization or analysis.

The present invention starts from the focus that such medical imaging storage systems contains a huge amount of medical information that could be exploited for increasing the human knowledge about health, and for improving the quality of diagnosis and therapy. Currently, the information contained into the large medical imaging databases is used only in minimal part. Mostly, medical images from one individual are used just to take care of her/his individual treatment. Just a few medical centers use medical images for scientific research, in which case the ability to select images is demanded to time-consuming procedures and are designed for specific purposes.

Any storage system contains a procedure for the retrieval of medical images. Such procedures, however, allow the retrieval of individual exams, or, sometime, permit very simple grouping concepts, because they were designed considering the clinical activity and the immediate patient care only. The search is typically based on patient name, to follow the clinical history of individual patients; or on the date of exams, to follow the clinical activity during a period. Sometime they use clinic, unit, or physician's details. The solutions permit to retrieve the single images or the overall clinical report made by the responsible after the exam.

The existing solutions do not allow to extract the medical information from sets of several exams and to obtain further information, principally required in terms of anonymous statistical results. Such can be, for example, the normal value of clinical indicators (like Ejection Fraction in cardiology) or the value of such indicators in selected sub-sets of population, like in children, in age-stratified population, separately in women and men, in athletes, or in patients with specific diseases. The quantitative specification of the physiological range for clinical indicators is the key references used worldwide to build a diagnosis. Very often, as yet, the figures are based on few results, on limited numbers, and are rarely updated in time.

### BRIEF SUMMARY

Provided herein is a method for medical imaging data management, particularly in distributed cloud environments, that permits a progressive increase of the exploitable knowledge accompanying medical imaging storage and retrieval by properly fitting in the workflow of a normal clinical activity.

The invention provides a method for medical imaging data management comprising:
receiving medical images associated with an exam of a patient;
storing said medical images;
receiving clinical information derived from said medical images;
arranging said clinical information in a database structured to allow retrieval of such clinical information independently from the retrieval of the stored medical images.

By accompanying the storage of a set of medical images with one entry in a database structure that contains a large number of fields, it is possible to build a meta-data structure containing many useful clinical indicators that, in particular when the database is of progressively growing dimension, would permit to exploit the information contained therein for the improvement of healthcare processes.

The clinical information may comprise clinical indicators and/or parameters related to the exam the clinical images refer to and is typically structured as a series of predefined fields with a predefined logical structure that can be filled, manually or automatically, for example, while reporting the analysis of an exam.

Such fields, that are numeric or informative (typically from a set of options), contain quantitative information on the medical features of the exam. As an exam is always accompanied by a clinical report compiled by the responsible physician, in the simplest configuration of the invention, such fields contain all or part of the information that the physician fills inside the report. In specific realizations the report can be simply a properly formatted presentation of the database information.

Advantageously some of these fields are automatically filled by extracting the information available in the set of images itself. In fact, images are typically stored in DICOM format; such a format contains several information stored following the DICOM standard, that permits the automatic extraction of the available information.

Most of these fields are, in the present invention, automatically filled by the implementation of a structured clinical report during the phase of exam storage.

The clinical report is, in this case, a digital report comprising a collection of entries whose structure and content is a function of the type of exam the clinical report refers to and is preferably arranged as a template that can be filled during the evaluation of an exam.

The availability of a meta-data structure comprising not only images, but also clinical information in the form of fields that can be queried, allows to perform statistical synthesis. For example the statistical synthesis can be performed by computing the average values and/or the range of variability of the clinical indicators stored in the database or reporting the intervals of normality of clinical parameters by performing the statistics on exams of patients not affected by pathologies.

The fields of the database are typically divided in homogeneous fields for an optimized retrieval of clinical information and specific sub-sets are advantageously used for performing statistical synthesis depending on the typology of the required data processing. To such extent the database may comprise sets of fields mapped directly into the various anatomical parts the exam refers to. For cardiology, for example, the sets of fields may relate to parameters regarding anatomical parts selected from the group consisting of: valves, atria, ventricular, veins and arteries.

According to another aspect, the invention relates to a medical data repository comprising an area for the storage of images related to exams of patients and an area for the storage of clinical information data related to such exams, which typically comprises one or more entries from a clinical report. The clinical information data are arranged as a series of predefined fields with a predefined logical structure that can be filled, manually or automatically, while reporting the analysis of an exam, the areas being so arranged that a subsequent retrieval of said clinical information can be performed independently from the retrieval of the related medical images to allow a statistical synthesis of clinical parameters and/or indicators contained in such clinical information.

As the images are typically stored in Dicom format, part of the fields of the clinical information are automatically filled extracting corresponding Dicom tags from the image files.

According to an improvement, the repository is a distributed storage of medical data like those normally used in a PACS, particularly a Web-based PACS, having connecting means for transferring healthcare information documents produced by one or more imaging modalities.

According to another aspect, the invention relates to a system for medical imaging data management comprising:
a storage of medical imaging data;
communication means for transferring medical images associated with an exam of a patient from an imaging modality to the storage;
a reporting unit for deriving clinical information data from said medical images, for example configured to receive clinical parameters and/or indicators as tags of a structured clinical report;
communication means for transferring clinical information from the reporting unit to the storage,
wherein the storage is arranged to allow retrieval of the clinical information independently from the retrieval of the related medical images to allow a statistical synthesis of such clinical information.

The system further comprises a reviewing unit for retrieving the clinical information and/or the images of the storage. The reviewing unit typically comprises a tool for selectively extracting entries from the database to perform a statistical analysis of the same. The images are advantageously stored in Dicom format, there being provided tools for extracting corresponding Dicom tags from the image files to automatically fill part of the clinical information fields.

According to a preferred embodiment, the storage is a distributed repository of medical data which is part of a PACS, particularly a Web-based PACS, the reviewing unit being one of the interfaces for allowing Web access to the stored information documents generated by the imaging modalities and/or the reporting unit.

### BRIEF DESCRIPTION OF THE DRAWINGS

The characteristics of the invention and the advantages derived therefrom will be more apparent from the following description of non-limiting embodiments, illustrated in the annexed drawings, in which:

FIG. 1 shows a simplified block diagram of a cloud computing environment according to the prior art.

FIG. 2 schematically shows how the storage process of FIG. 1 can be improved according to an embodiment of the invention.

FIG. 3 shows exemplary sets of entries of a database structure according to the invention.

FIG. 4 shows an exemplary list of tags related to patient data in a Dicom file.

### DETAILED DESCRIPTION

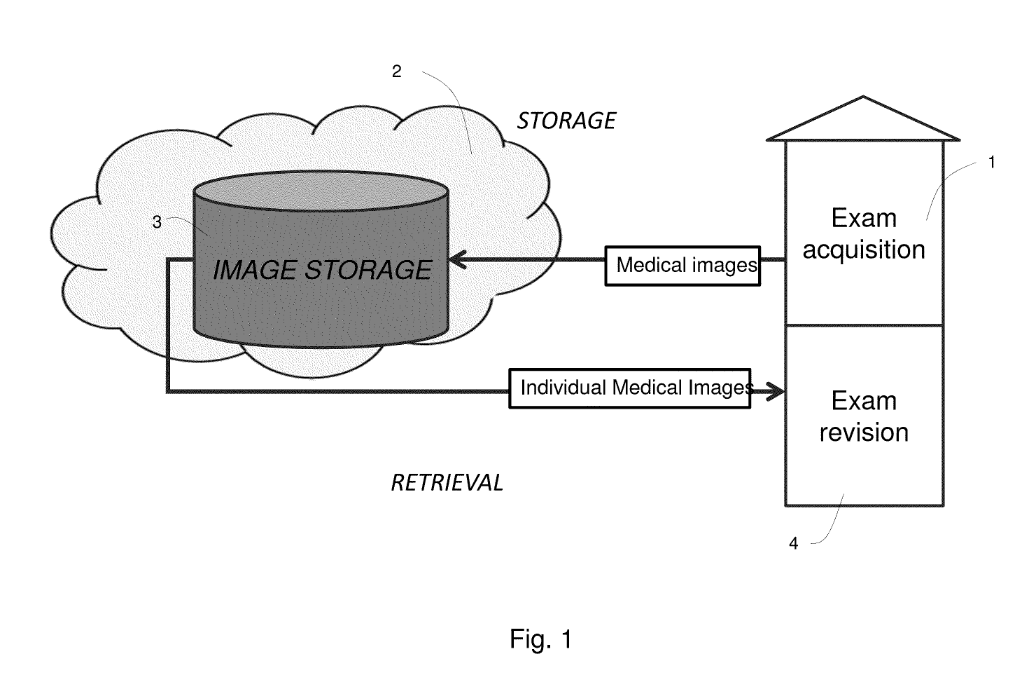

FIG. 1 shows a typical flux of information in a system for managing medical data. The massive medical data acquired with the imaging equipment(s) 1 is stored in the cloud 2 according to any known method as disclosed, for example, in U.S. patent application published with number 2012/0046972 which is to be considered herein incorporated by reference. To take advantage of a distributed cloud environment, the storage 3 and the medical equipment(s) performing image acquisition 1 are preferably interconnected through the Internet in the form of a so-called Web-based PACS. The retrieving stations 4 can be in the same institution of the imaging modality 1, as exemplary sketched in the figure, or can be located remotely worldwide and are typically connected through the internet.

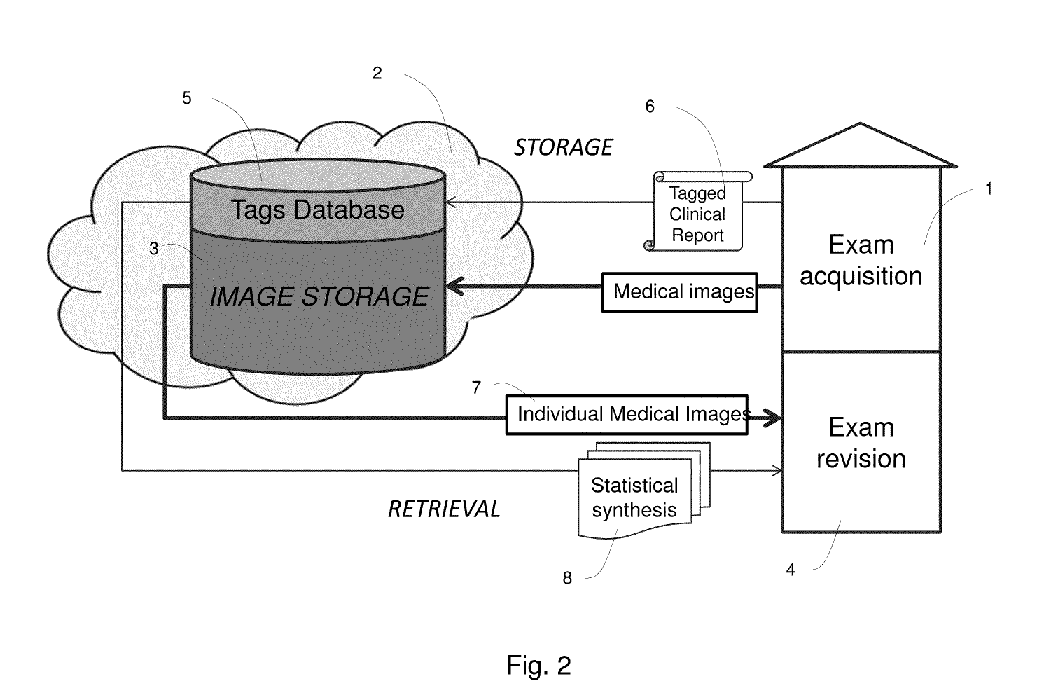

FIG. 2 shows how the system of FIG. 1 could be modified according to the teachings of the present invention. The storage process is accompanied by the preparation of a clinical report 6 containing series of tags, that can be expressed in numerical format. Such tags are stored in a database 5 accompanying the global storage 3. The retrieval process is performed either in terms of individual images 7 or in terms of statistical synthesis 8 of sets on the database entries 5.

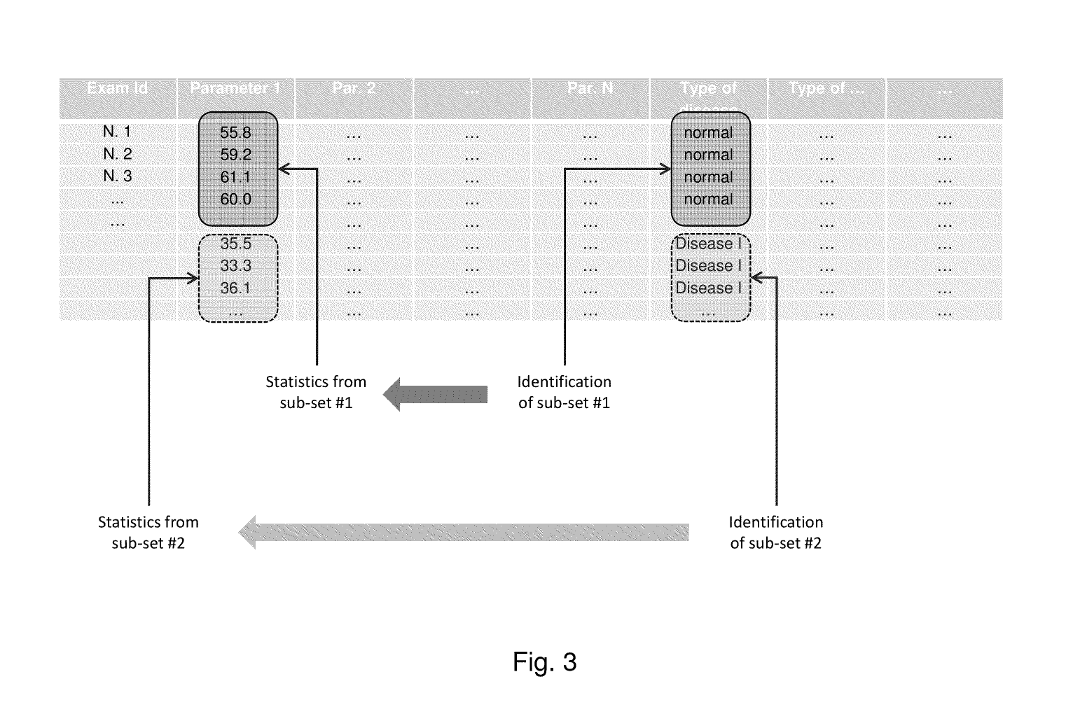

FIG. 3 shows exemplary sets or sub-sets of the database entries upon which the statistical analysis is performed. The identification of specific sub-sets is performed through the database 5 that permits to extract the corresponding values of desired parameters.

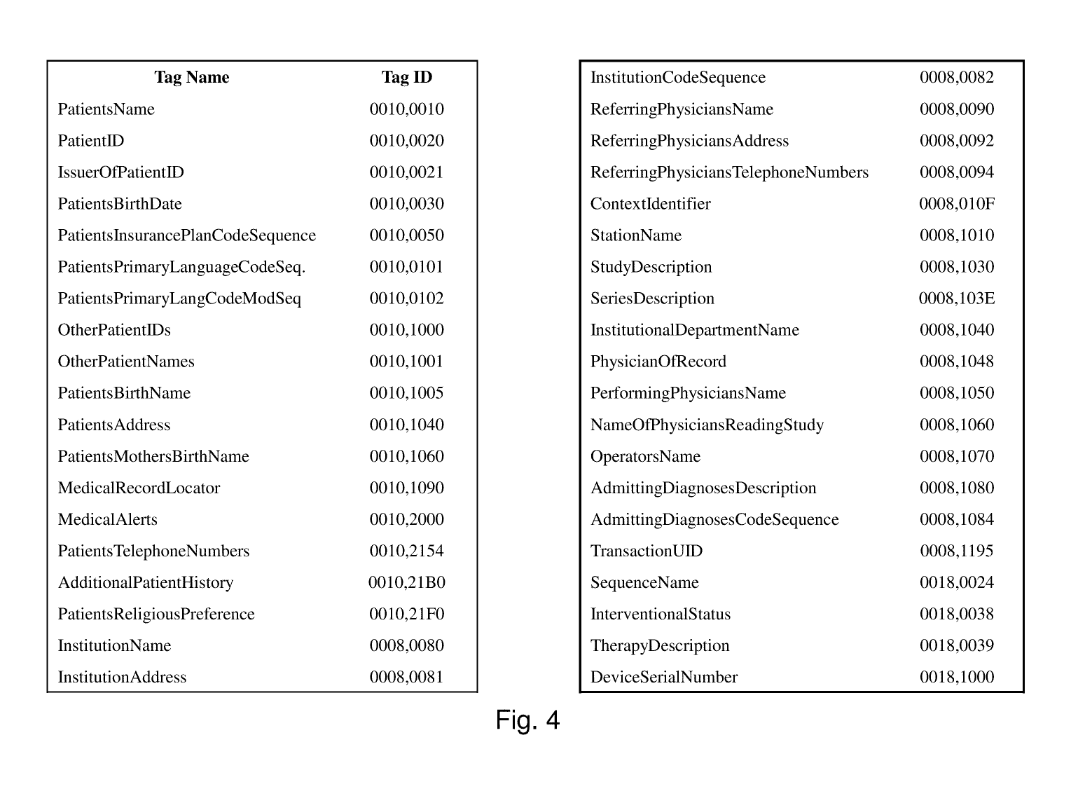

Some of the fields of the database 6 are automatically filled by extracting the information available in the set of images itself. In fact, images are typically stored in DICOM format; such a format contains several information stored following the DICOM standard, that permits the automatic extraction of the available information. FIG. 4 shows an exemplary list of Dicom tags related to patient personal data that are commonly included in Dicom files.

Most of the database fields are automatically filled by the implementation of an advantageous structured clinical report during the phase of exam storage. In fact, every storage must be accompanied by a clinical report and, in every clinical specialty proper reports should follow rigid standards accordingly with the guidelines of the international organizations. For example in cardiology, the guidelines are jointly given by the American Heart Association (AHA) the American College of Cardiology (ACC) and the European Society of Cardiology (ESC). Following the appropriate guidelines, it is advantageous to structure the clinical report in a series of predefined fields with a predefined logical structure. Such a structure can be arranged in a template that can be filled during the evaluation of the exam within the normal workflow. Such a clinical report becomes a collection of tags with a numeric value associated to each tag. The informative tags within the report are used to fill the many fields of the database of the medical imaging exam. Fields that can be numeric, Boolean, multi-choices, or free text; they can be filled directly, or filled with measurements obtained by image analysis, or automatically generated on the basis of the values in other fields. In the simplest perspective, the database structure can be made of a set of fields; specific applications of medical specialties may benefit of a branching structure with multiple levels and dependent fields. Fields can be logically divided in sets mapped directly into the various anatomical parts taken into account, in order to be easily associated to used templates. As an example, in cardiology sets can be associated to valves, atria, ventricula, veins and arteries. More reliably, fields in database can be divided in homogeneous sets designed to fulfill optimized research time. This is particularly important when huge database are split or distributed in a shared network. So, sets can be defined according to the time of their insertion and update, or according to patient residence area or according to usage rate and occurrence. Templates and stored sets can be mapped one another directly from within the database or by external tools.

Relations between dependent fields can be stored as static entries in the database and used to perform automatic calculation of dependent tags by the database itself or by external applications allowed to access data.

The database can store fields and relations according to a relational database standard structure, but information can be also stored in lesser traditional structures that optimize space and search time, such as “not transactional” database, “no sql” database and memory mapped applications that mirrors periodically their content on disk but are mainly used as in-memory in-process or inter-process applications.

This approach changes the medical imaging storage structure from that of a database of identifiable images, to metadata organization where images are accompanied and integrated by additional related information.

Once the storage of the medical imaging exam is part of a metadata structure, these data can be employed to perform search and statistical search operation within the metadata.

This can be achieved by accompanying such a metadata storage structure with retrieval tools capable to perform a series of statistical synthesis of the stored data.

The normal storage system allows retrieving the information of individual exams or group of exams on the basis of a few indicators; like patient name, exam date, physician's or institution details, sometimes more advanced searches, following the same concept, are available.

The present invention proposes to accompany the standard, or novel, retrieval strategies, with a tool capable to evaluate additional synthetic medical information from the continuously growing database. In the simplest realization this tool is capable to compute and report the average values, and the range of variability, for the clinical indicators stored in the database. Therefore report the intervals of normality for parameters, by performing the statistics on exams that were defined as normal, not affected by pathologies. This can be performed on all parameters available thus enriching the diagnostic ability of users. The statistical syntheses can also be performed on specified sub-sets of the database, like on the set of patients that are judged as affected by a same pathology or that have in common a series of other indicators. This would allow verifying whether a patient properly fits in a specific pathology or whether it differentiates.

Overall, the accompanying tool includes the ability of extracting the statistical properties of all useful clinical indicators from the growing database. The complexity of such a statistical analysis can be implemented from the basic levels, averages, ranges, to arbitrarily advanced statistical analysis, conditional statistics, applied to subsets, comparisons between sub-sets. And eventually including graphic representations in terms of histograms, charts etc. The same tool can be immediately equipped with further function based on geo-localization, resource optimization, monitoring of processes, etc.

Quantification tools can remotely process the original data to obtain a statistical result, such statistical result being available to the users in place of the original data or along with the original data to improve knowledge, for example for setting up a database of known cases that could be consulted world-wide or a database containing synthesis of quantitative information as could be built by analysis of information that are distributed over the many medical centers.

The processing of sensible data are advantageously performed in one or more protected dedicated areas of the system, there being provided security and data management means for preventing an authorized user from gaining access to said data. Any kind of security means can used for the purpose. For example those commonly used in PACS systems as far as access control, confidentiality, data integrity are concerned. For detailed technical descriptions on data security, reference may be made to the International Organization for Standardization (ISO) security architecture defined in section 5 of ISO/IEC 7498-2. A very powerful means for handling sensible data and distributing the same anonymously for setting up a database for improving the human knowledge is the one disclosed in U.S. application published with number 2012/0046972 which is to be considered herein incorporated by reference. The present invention could be seen as an improvement of the system therein disclosed.

Although the invention has been mainly described with reference to a Web-based PACS which certainly represents the most appropriate solution, this is not to be considered a limiting feature. It can, in fact, be appreciated that its teachings can be advantageously applied in any environment where a storage of medical data is present whichever is the means for updating such storage, the location of the same and the technical means of communications used.

Furthermore it is to be noted that the image storage and the tag database have been shown in FIG. 2 as separate entities to allow the reader to immediately grasp the teachings of the present invention. Obviously the structure can be integrated in a single database wherein the images represent one of the available fields to obtain a powerful meta-structure of data.

1. A medical imaging data management method comprising:
receiving medical images associated with an exam of a patient;
storing said medical images;
receiving clinical information derived from said medical images;
arranging said clinical information in a database structured to allow retrieval of such clinical information independently from the retrieval of the stored medical images.

2. Method according to claim 1, wherein clinical information comprises clinical indicators and/or parameters related to the exam the clinical images refer to.

3. Method according to claim 1, wherein the clinical information is structured as a series of predefined fields with a predefined logical structure that can be filled, manually or automatically, while reporting the analysis of an exam.

4. Method according to claim 1, wherein the images are stored in Dicom format, part of the fields of the clinical information being automatically filled extracting corresponding Dicom tags from the image files.

5. Method according to claim 1, wherein clinical information comprises one or more entries from a clinical report.

6. Method according to claim 5, wherein the clinical report is a digital report comprising a collection of entries whose structure and content is a function of the type of exam the clinical report refers to.

7. Method according to claim 6, wherein the clinical report is arranged as a template that can be filled during the evaluation of an exam.

8. Method according to claim 1, further comprising retrieving said clinical information from the database to perform statistical synthesis.

9. Method according to claim 8, wherein statistical synthesis is performed by computing the average values and/or the range of variability of the clinical indicators stored in the database.

10. Method according to claim 8, wherein the clinical information is retrieved for reporting the intervals of normality of clinical parameters by performing the statistics on exams of patients not affected by pathologies.

11. Method according to claim 8, wherein statistical synthesis is performed on specific sub-sets of the database.

12. Method according to claim 1, wherein the database comprises sets of fields mapped directly into the various anatomical parts the exam refers to.

13. Method according to claim 12, wherein, for cardiology, the sets of fields relate to parameters regarding anatomical parts selected from the group consisting of: valves, atria, ventricular, veins and arteries.

14. Method according to claim 1, wherein the fields of the database are divided in homogeneous fields for an optimized retrieval of clinical information.

15. A medical data repository comprising an area for the storage of images related to exams of patients and an area for the storage of clinical information data related to such exams, wherein the clinical information data are arranged as a series of predefined fields with a predefined logical structure that can be filled, manually or automatically, while reporting the analysis of an exam, the areas being so arranged that a subsequent retrieval of said clinical information can be performed independently from the retrieval of the related medical images to allow a statistical synthesis of clinical parameters and/or indicators contained in such clinical information.

16. Repository according to claim 15, wherein the images are stored in Dicom format, part of the fields of the clinical information being automatically filled extracting corresponding Dicom tags from the image files.

17. Repository according to claim 15, wherein such repository is a distributed storage of medical data.

18. Repository according to claim 15, wherein clinical information comprises one or more entries from a clinical report.

19. Repository according to claim 15, wherein such repository is part of a PACS, particularly a Web-based PACS, having connecting means for transferring healthcare information documents produced by one or more imaging modalities.

20. System for medical imaging data management comprising:
a storage of medical imaging data;
communication means for transferring medical images associated with an exam of a patient from an imaging modality to the storage;
a reporting unit for deriving clinical information data from said medical images;
communication means for transferring clinical information from the reporting unit to the storage,
wherein the storage is arranged to allow retrieval of the clinical information independently from the retrieval of the related medical images to allow a statistical synthesis of such clinical information.

21. System according to claim 20, further comprising a reviewing unit for retrieving the clinical information and/or the images of the storage.

22. System according to claim 21, wherein the reviewing unit comprises a tool for selectively extracting entries from the database to perform a statistical analysis of the same.

23. System according to claim 20, wherein the storage is a distributed repository of medical data.

24. System according to claim 21, wherein the storage is part of a PACS, particularly a Web-based PACS, the reviewing unit being one of the interfaces for allowing Web access to the stored information documents generated by the imaging modalities and/or the reporting unit.

25. System according claim 20, wherein the images are stored in Dicom format, there being provided tools for extracting corresponding Dicom tags from the image files to automatically fill part of the clinical information fields.

26. System according claim 20, wherein the reporting unit is configured to receive clinical parameters and/or indicators as tags of a structured clinical report.
